(19) United States
(12) Patent Application Publication
(10) Pub. No.: US 2007/0101360 A1
(43) Pub. Date: May 3, 2007

(54) Commercial insertion into video streams based on surrounding program content

(75) Inventors: Srinivas Gutta, Veldhoven (NL); Petrus Gerardus Meuleman, Eindhoven (NL); Wilhelmus Franciscus Johannes Verhaegh, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., Eindhoven (NL)

(21) Appl. No.: 10/579,302

(22) PCT Filed: Nov. 15, 2004
(86) PCT No.: PCT/IB04/52424

§ 371 Date: May 16, 2006

Related U.S. Application Data
(60) Provisional application No. 60/520,621, filed on Nov. 17, 2003.

(51) Int. Cl. H04N 7/10; H04N 7/025; G06F 13/00; H04N 5/445; G06F 3/00

(52) U.S. Cl. 725/34; 725/35; 725/46

(57) ABSTRACT

A method for inserting replacement commercials into a data stream is provided. The method including: receiving the data stream; detecting at least one commercial in the data stream; determining a characteristic of program content at least prior to the at least one commercial; and replacing the at least one commercial in the data stream with a replacement commercial which is selected based at least in part on the determining.

The invention relates generally to televisions and other monitors and commercials and, more particularly, to a method and apparatus for inserting commercials into a data stream based on the content of the surrounding program.

Commercials are inserted into a television broadcast by a commercial producer, or sometimes local commercials are inserted by a cable television provider. It is known in the prior art to store commercials and to insert the same into a live broadcast stream by temporarily replacing the live stream by a playout of blocks from memory. In this way, the original commercial blocks in the live broadcast stream can be replaced by other commercial blocks. However, in this approach, the inserted block of commercials must last equally as long as the block that it replaces. It is also known in the art to delay a live television broadcast stream by means of an additional memory to replace the commercials in the live broadcast stream with longer length commercials or shorter length commercials. The receiver uses a memory not only to delay the program blocks in the live broadcast stream but also to create a delayed stream. If a commercial longer than the available gap in the live broadcast stream is to be inserted, the resumption of the live stream is delayed. However, this delay may be used in a next block of content to be replaced to insert a new content block that lasts shorter. In this way, more freedom is created to replace content blocks than is possible with the method described above. Co-pending U.S. application Ser. No. 10/______ (attorney Docket US030439), the contents of which are incorporated herein by its reference, discloses methods and devices for inserting replacement commercials into a data stream by detecting one or more commercial portions of the data stream and replacing the detected commercial portions with either more or less replacement commercial portions.

However, the original and/or replacement commercials are often of little interest to the viewer. Accordingly, various schemes have been developed for inserting particular commercials based on information associated with the viewer. For example, the commercial breaks can be detected using known techniques, and a suitable commercial can be aired during the break. The commercial may be obtained from one or more virtual commercial channels where only commercials are present. The particular commercial that is played can be selected based on demographic factors such as the viewer's age, gender, income and the like. While such approaches can be acceptable, they do not take into account the content of the television program in which the commercials are inserted.

One specific problem currently faced by viewers is where the commercials are in some way inconsistent with the surrounding program content. For example, where a viewer is watching a suspense movie with dark scenes and during a commercial break a commercial is shown with a bright contrast. This can cause disorientation for the viewer because it takes time for the user's eyes to adjust to the bright commercial. Similarly, the viewer can be watching a slow romantic movie that is suddenly interrupted by a fast and/or loud commercial. This could also cause discomfort to the viewer. Furthermore, a listener can be listening to slow romantic audio that is interrupted by loud commercials that ruin the mood of the audio.

Therefore it is an object of the present invention to provide methods and interactive systems that overcome these and other disadvantages associated with the prior art.

Accordingly, a method for inserting replacement commercials into a data stream is provided. The method comprising: receiving the data stream; detecting at least one commercial in the data stream; determining a characteristic of program content at least prior to the at least one commercial; and replacing the at least one commercial in the data stream with a replacement commercial which is selected based at least in part on the determining.

The characteristic can be an audio characteristic in the program content at least prior to the at least one commercial.

The audio characteristic can be a speech pattern of the program content at least prior to the at least one commercial. In which case, the replacing can comprise replacing the at least one commercial with a replacement commercial having a speech pattern within a predetermined threshold of the speech pattern of the program content at least prior to the at least one commercial. The speech pattern can be selected from a group consisting of pitch and intonation.

The audio characteristic can be a music characteristic in the program content at least prior to the at least one commercial. In which case, the replacing can comprise replacing the at least one commercial with a replacement commercial having a music characteristic within a predetermined threshold of the music characteristic in the program content at least prior to the at least one commercial. The music characteristic can be selected from a group consisting of beats, tempo, rhythm, and genre.

The characteristic can be a visual characteristic in the program content at least prior to the at least one commercial. In which case, the replacing can comprise replacing the at least one commercial with a replacement commercial having a visual characteristic within a predetermined threshold of the visual characteristic in the program content at least prior to the at least one commercial. The visual characteristic can be selected from a group consisting of texture, color, compositions, and objects.

The characteristic can be one or more electronic program guide (EPG) characteristics of the program content at least prior to the at least one commercial. In which case, the replacing can comprise replacing the at least one commercial with a replacement commercial having one or more EPG characteristics within a predetermined threshold of the EPG characteristics in the program content at least prior to the at least one commercial. The one or more EPG characteristics can be a genre.

The method can further comprise: determining a recommendation for a viewer based on at least one of the viewer's viewing behavior and explicit recommendations of the viewer; wherein the replacing further comprises replacing the at least one commercial in the data stream with a replacement commercial which also is selected based at least in part on the recommendation.

Also provided is a device for inserting replacement commercials into a data stream. The device comprising a processor for receiving the data stream, detecting at least one commercial in the data stream, determining a characteristic of program content at least prior to the at least one commercial, and replacing the at least one commercial in the data stream with a replacement commercial which is selected based at least in part on the characteristic determination.

Where the data stream is a video data stream, the device can further comprise a display operatively connected to the processor for displaying video corresponding to the video data stream. Where the data stream is an audio data stream, the device can further comprise at least one speaker operatively connected to the processor for reproducing audio corresponding to the audio data stream.

The device can further comprise: a recommender system for determining a recommendation for a viewer based on at least one of the viewer's viewing behavior and explicit recommendations of the viewer; wherein the processor replaces the at least one commercial in the data stream with a replacement commercial which also is selected based at least in part on the recommendation.

Also provided are a computer program product for carrying out the methods of the present invention and a program storage device for the storage of the computer program product therein.

These and other features, aspects, and advantages of the apparatus and methods of the present invention will become better understood with regard to the following description, appended claims, and accompanying drawings where:

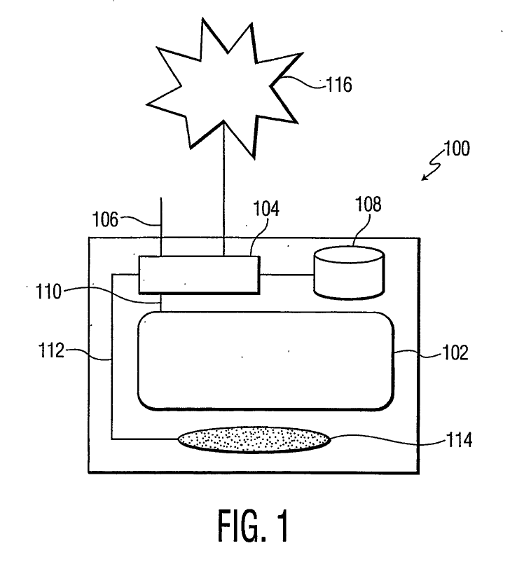

FIG. 1 illustrates a schematic of a first device for carrying out the methods of the present invention.

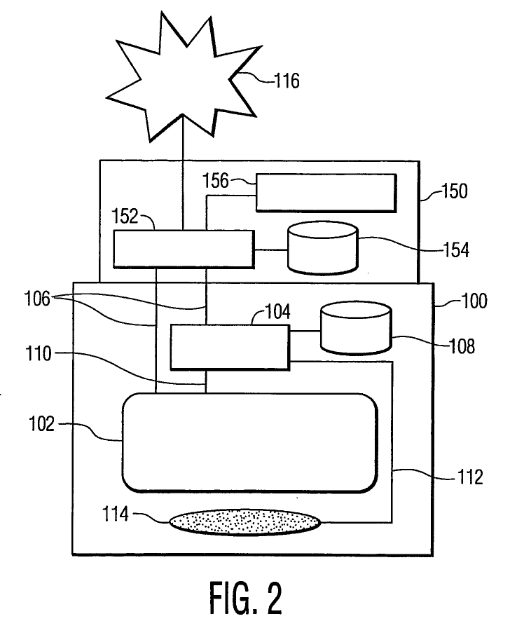

FIG. 2 illustrates a schematic of a second device for carrying out the methods of the present invention.

Although this invention is applicable to numerous and various types of devices, it has been found particularly useful in the environment of televisions and other monitors for displaying video and/or images. Therefore, without limiting the applicability of the invention to televisions and other monitors, the invention will be described in such environment. However, those skilled in the art will appreciate that the devices of the present invention can also reproduce audio, such as radio tuners. Furthermore, although the invention is described below with regard to a “broadcast” data stream, those skilled in the art will appreciate that the same is discussed by way of example only and not to limit the invention thereto. For example, the invention is equally applicable to streaming video content as well which can be viewed via the Internet using a broadband network.

Referring now to FIG. 1, there is illustrated a first device for inserting commercials into a data stream, the first device being configured as a television 100. The television has a display screen 102 such as a CRT, an LCD, or a projection screen. The television 100 further has a processor 104 that receives the data stream in the form of a video content (hereinafter referred to simply as “video”) input signal 106. The video input signal 106 can be from any source known in the art, such as cable, broadcast television, satellite, or an external source such as a tuner, VCR, DVD, or set-top box. The video input signal 106 can be a broadcast signal or streaming video, such as from the Internet. The video input signal contains both program content portions and original commercial portions. The program portions can be sporting events, television shows, movies and the like. The original commercial portions can be one or more advertisements for products and/or services, public announcements, and the like. The processor 104 is further operatively connected to a storage device 108 for storing data, settings, and/or program instructions for carrying out the conventional functions of the television 100 as well as the methods of the present invention. Although shown as a single storage device 108, the same may be implemented in several separate storage devices that may be any of many different types of storage devices known in the art.

The processor 104 receives the video input signal 106, processes the same, as necessary, as is known in the art and outputs a signal 110 to the display screen in a format compatible with the display screen 102. The display screen 102 displays a video portion of the video input signal 106. An audio portion 112 of the video input signal 106 is reproduced on one or more speakers 114 also operatively connected to the processor 104. The one or more speakers 114 may be integral with the television 100, as shown in FIG. 1 or separable therefrom.

Referring now to FIG. 2, there is shown a second device for inserting commercials into a data stream, the second device being configured as an external source, such as a set-top box, tuner, computer, DVD, or VCR. The external source is generally referred to herein by reference numeral 150 and refers generally to any device that supplies a video input signal to a display device, such as the television 100. In the configuration of FIG. 2, the television 100 may be as configured in FIG. 1 or it may simply be a monitor under the control of a processor 152 contained in the external source 150. Thus, as shown in FIG. 2, the input video signal 106 from the processor 152 of the external source 150 may be directly input to the display screen 102 or to the display screen via the television processor 104. The processor 152 is operatively connected to a storage device 154 which may be implemented as one or more separable storage devices. The storage device 154 includes data and settings as well as program instructions for the normal operation of the external source and/or television 100 as well as for carrying out the methods of the present invention. The external source 150 may also include a recommender 156 for generating a user profile based on an implicit and/or explicit recommendation of the viewer's viewing preferences. Generation of recommendations is well known in the art. Implicit recommendations are formed from an analysis of the viewer's viewing behavior while explicit recommendations are generated from feedback entered by the viewer regarding his/her likes and dislikes. The recommendation generated can also use a combination of the implicit and explicit methods. Although shown separable from the processor 152, the recommender can be a set of instructions that is carried out by the processor 152.

As will be discussed below, depending upon the configuration of the device, the processor 104, 152 receives the data stream 106, detects at least one commercial in the data stream 106, determines a characteristic of program content at least prior to the commercial, and replaces the commercial in the data stream with a replacement commercial which is selected based at least in part on the characteristic determination. The processor 104, 152 can also replace the commercial in the data stream with a replacement commercial which also is selected based at least in part on the recommendation generated by the recommender system 156.

The processor 104, 152 can be operatively connected to a remote network 116, such as through a modem (not shown) under the control of the processor 104, 152. The remote network 116 can contain a database of replacement commercials that is remotely stored and which may be an Internet web site. The replacement commercials may also be stored locally at the storage device 108, 154 which can be periodically updated from the remote network 116. The replacement commercials may also be appended to the data stream 106 and used “on the fly” or stored periodically at the storage device 108, 152. As discussed above, the replacement commercials can also be located at another channel in the data stream. If the storage device 108, 152 or allocated portion thereof becomes full with replacement commercials, they can be purged by any methods known in the art such as “first-in-first-out” (fifo). Alternatively, the replacement commercials can be purged according to their dissimilarity with the viewer's user profile as generated by the recommendation system 156.

A method for inserting replacement commercials into a data stream will now be discussed with regard to FIGS. 1 and 2. The method includes receiving the data stream. As discussed above, the data stream can be a cable transmission, a broadcast transmission, a satellite transmission, or streaming data. The processor 104, 152 is assumed to have or be operatively connected with any hardware necessary to receive, demultiplex, and format such transmissions for display on the display screen 102 and/or reproduction on the speaker 114. The processor 104, 152 further detects at least one commercial in the data stream 106 and possibly each commercial in the data stream 106. Methods for detecting commercials in a data stream are well known in the art.

The processor 104, 152 next determines a characteristic of program content at least prior to the (each) detected commercial. The determination can also be made after the (each) commercial; however, such would involve storing the data stream and delaying its display and/or reproduction. The characteristic can be any characteristic of the program content. After the characteristic(s) are determined, the (each) commercial in the data stream is replaced with a replacement commercial that is selected based at least in part on the determination. As discussed above, the replacement commercial can be selected from a database at the remote network 116, at the storage device 108, 154, or from the data stream 106 itself. The processor 104, 152 is assumed to have or to be operatively connected to any hardware necessary to retrieve the replacement commercials from a source and to format and insert the same into the data stream or otherwise display and/or reproduce the replacement commercial.

One example of such a characteristic is an audio characteristic in the program content, such as a speech pattern in the program content or a music characteristic in the program content. In the case of a speech pattern, the replacing of the commercials in the data stream 106 can comprise replacing the commercial with a replacement commercial having a speech pattern within a predetermined threshold of the speech pattern of the program content at least prior to the commercial. Thus, the speech pattern of the replacement commercial(s) must be determined or identified and compared with the speech pattern of the program content surrounding the commercial to determine a degree of similarity. If the speech pattern of the replacement commercial and program content are similar, the replacement commercial can be inserted in place of the original commercial. Examples of speech patterns are pitch and intonation. Detection of speech patterns in data is well known in the art.

Similarly, in the case of a music characteristic, the replacing of the commercials in the data stream 106 with a replacement commercial can comprise replacing the commercial with a replacement commercial having a music characteristic within a predetermined threshold of the music characteristic in the program content at least prior to the commercial. Thus, one or more of the music characteristics of the replacement commercials must be determined or identified and compared with the corresponding music characteristics of the program content surrounding the commercial to determine a degree of similarity. If the music characteristic(s) of the replacement commercial and program content are similar, the replacement commercial can be inserted in place of the original commercial. Examples of music characteristics are beats, tempo, rhythm, and genre. Detection of such music characteristics are well known in the art.

Another example of a characteristic of the program content can be a visual characteristic of the program content at least prior to the (each) commercial. In which case, the replacing of the original commercial(s) in the data stream with a replacement commercial can comprise replacing the original commercial with a replacement commercial having a visual characteristic within a predetermined threshold of the visual characteristic in the program content at least prior to the at least one commercial. Thus, one or more of the visual characteristics of the replacement commercials must be determined or identified and compared with the corresponding visual characteristics of the program content surrounding the commercial to determine a degree of similarity. If the visual characteristic(s) of the replacement commercial and program content are similar, the replacement commercial can be inserted in place of the original commercial. Examples of visual characteristics can include texture, color, compositions, and objects. Detection of such visual characteristics in program content are well known in the art.

Still another example of a characteristic is one or more electronic program guide (EPG) characteristics of the program content at least prior to the at least one commercial. In which case the replacing of the original commercial(s) in the data stream with a replacement commercial can comprise replacing the at least one commercial with a replacement commercial having one or more EPG characteristics within a predetermined threshold of the EPG characteristics in the program content at least prior to the at least one commercial. Thus, one or more of the EPG characteristics of the replacement commercials must be determined or identified and compared with the corresponding EPG characteristics of the program content surrounding the commercial to determine a degree of similarity. If the EPG characteristic(s) of the replacement commercial and program content are similar, the replacement commercial can be inserted in place of the original commercial. An example of an EPG characteristic is genre.

In the examples above, the characteristic(s) of the program content is compared to corresponding characteristic(s) of the replacement commercials to determine which, if any, of the replacement commercials can be inserted into an original commercial block in the data stream. The comparison can determine the characteristics of the replacement commercials from an analysis of the same or such information can be supplied with the replacement commercials, such as by a look-up table or appended to the replacement commercial itself.

The methods described above can also utilize a recommendation in determining a suitable replacement commercial. The recommendation can be used in combination with one or more characteristics of the program portion. Thus, the method can include determining a recommendation for a viewer. As is known in the art, the determination can be based on the viewer's viewing behavior and/or explicit recommendations from the viewer. In which case, the replacing of the original commercial(s) in the data stream with a replacement commercial can comprise replacing the commercial(s) in the data stream with a replacement commercial that also is selected based at least in part on the recommendation. The generation of recommendations to build a user profile based on implicit and/or explicit recommendations is well known in the art. Furthermore, it is known in the art to replace commercials in a data stream based on user preferences, such as that disclosed in World Patent Application WO 01/33848 A1, the contents of which are incorporated herein by its reference.

Of course, any combination of the above examples or any other characteristics can be used in determining a replacement commercial for insertion in the data stream. Furthermore, each of the characteristics and/or the recommendation can be assigned a different weighing factor so that some characteristics and/or the recommendation can be weighed more or less than others. The weighing factors can be assigned by the viewer through a suitable user interface.

The viewer can decide that he/she wants to view all of the original commercials in the data stream and does not want to replace any of the commercials in the data stream, such as during a broadcast of the super bowl. Thus, the viewer can toggle between settings that enable and disable the methods of the present invention, such as through a suitable user interface.

The methods of the present invention are particularly suited to be carried out by a computer software program, such computer software program preferably containing modules corresponding to the individual steps of the methods. Such software can of course be embodied in a computer-readable medium, such as an integrated chip or a peripheral device.

While there has been shown and described what is considered to be preferred embodiments of the invention, it will, of course, be understood that various modifications and changes in form or detail could readily be made without departing from the spirit of the invention. It is therefore intended that the invention be not limited to the exact forms described and illustrated, but should be constructed to cover all modifications that may fall within the scope of the appended claims.

1. A method for inserting replacement commercials into a data stream, the method comprising:
receiving the data stream;
detecting at least one commercial in the data stream;
determining a characteristic of program content at least prior to the at least one commercial; and
replacing the at least one commercial in the data stream with a replacement commercial which is selected based at least in part on the determining.

2. The method of claim 1, wherein the characteristic is an audio characteristic in the program content at least prior to the at least one commercial.

3. The method of claim 2, wherein the audio characteristic is a speech pattern of the program content at least prior to the at least one commercial.

4. The method of claim 3, wherein the replacing comprises replacing the at least one commercial with a replacement commercial having a speech pattern within a predetermined threshold of the speech pattern of the program content at least prior to the at least one commercial.

5. The method of claim 3, wherein the speech pattern is selected from a group consisting of pitch and intonation.

6. The method of claim 2, wherein the audio characteristic is a music characteristic in the program content at least prior to the at least one commercial.

7. The method of claim 6, wherein the replacing comprises replacing the at least one commercial with a replacement commercial having a music characteristic within a predetermined threshold of the music characteristic in the program content at least prior to the at least one commercial.

8. The method of claim 6, wherein the music characteristic is selected from a group consisting of beats, tempo, rhythm, and genre.

9. The method of claim 1, wherein the characteristic is visual characteristic in the program content at least prior to the at least one commercial.

10. The method of claim 9, wherein the replacing comprises replacing the at least one commercial with a replacement commercial having a visual characteristic within a predetermined threshold of the visual characteristic in the program content at least prior to the at least one commercial.

11. The method of claim 9, wherein the visual characteristic is selected from a group consisting of texture, color, compositions, and objects.

12. The method of claim 1, wherein the characteristic is one or more electronic program guide (EPG) characteristics of the program content at least prior to the at least one commercial.

13. The method of claim 12, wherein the replacing comprises replacing the at least one commercial with a replacement commercial having one or more EPG characteristics within a predetermined threshold of the EPG characteristics in the program content at least prior to the at least one commercial.

14. The method of claim 9, wherein the one or more EPG characteristics is genre.

15. The method of claim 1, further comprising:
determining a recommendation for a viewer based on at least one of the viewer's viewing behavior and explicit recommendations of the viewer;
wherein the replacing further comprises replacing the at least one commercial in the data stream with a replacement commercial which also is selected based at least in part on the recommendation.

16. A device (100, 150) for inserting replacement commercials into a data stream, the device comprising a processor (104, 152) for receiving the data stream, detecting at least one commercial in the data stream, determining a characteristic of program content at least prior to the at least one commercial, and replacing the at least one commercial in the data stream with a replacement commercial which is selected based at least in part on the characteristic determination.

17. The device of claim 16, wherein the data stream is a video data stream and the device further comprising a display (102) operatively connected to the processor for displaying video corresponding to the video data stream.

18. The device of claim 16, wherein the data stream is an audio data stream and the device further comprising at least one speaker (114) operatively connected to the processor for reproducing audio corresponding to the audio data stream.

19. The device of claim 16, further comprising:
a recommender system (156) for determining a recommendation for a viewer based on at least one of the viewer's viewing behavior and explicit recommendations of the viewer;
wherein the processor replaces the at least one commercial in the data stream with a replacement commercial which also is selected based at least in part on the recommendation.

20. A computer program product embodied in a computer-readable medium for inserting replacement commercials into a data stream, the computer program product comprising:
computer readable program code means for receiving the data stream;
computer readable program code means for detecting at least one commercial in the data stream;
computer readable program code means for determining a characteristic of program content at least prior to the at least one commercial; and
computer readable program code means for replacing the at least one commercial in the data stream with a replacement commercial which is selected based at least in part on the determining.

21. The method according to claim 1, wherein a program storage device readable by machine, tangibly embodying a program of instructions executable by the machine performs the method steps for inserting replacement commercials into a data stream.
